(19) United States
(12) Patent Application Publication
(10) Pub. No.: US 2018/0337503 A1
(43) Pub. Date: Nov. 22, 2018

(54) Electrical Outlet Assembly with Rotational Connect and Disconnect Feature

(71) Applicant: SUNGHOON SAMUEL OH, HARBOR CITY, CA (US)

(72) Inventor: SUNGHOON SAMUEL OH, HARBOR CITY, CA (US)

(21) Appl. No.: 15/599,254

(22) Filed: May 18, 2017

(51) Int. Cl. H01R 39/64; H01R 31/06; H01R 24/30

(52) U.S. Cl. CPC H01R 39/64; H01R 24/30; H01R 31/06

(57) ABSTRACT

An electrical outlet assembly is provided herein with a rotating receptacle inside of a housing assembly. Rotational mechanism built into the receptacle and housing assembly with mating structures inside can be engaged and disengaged at pre-defined angles. The outlet assembly consists of a receptacle, housing assembly (base housing and top housing), and electrical contacts. The receptacle has internal structures that can guide prongs of an electrical plug when inserted and rotated. When the receptacle is rotated to a specific angle position, the prongs are pressed against the electrical contacts installed on contact supports of the base housing. When the electrical plug is rotated to another specific angle position, the prongs are no longer pressed against the electrical contacts and the electrical plug can be released from the receptacle without ease.

### CROSS-REFERENCE TO RELATED APPLICATIONS

The invention was disclosed on a provisional patent application submitted by the inventor. Application number 62/339,956 dated May 23, 2016.

### STATEMENT REGARDING FEDERALLY SPONSORED R&D

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM

Not Applicable.

### BACKGROUND

### Technical Field

This invention solves the problem of current method of unplugging an electrical plug from a conventional electrical outlet that often requires both hands to be used in an awkwardly bent down position while struggling to release the plug from the outlet. The invention presents an electrical outlet assembly with easy to release rotational mechanism for disconnecting the electrical plug that greatly facilitates the unplugging experience. Conventional relocatable power taps are often difficult to unplug electrical plugs from outlets due to the design of electrical contacts being stamped brass strips with slots that allow insertion of prongs of the electrical plugs. The slots on the electrical contacts grab onto the prongs of the electrical plug very tightly during early stages of usage but often loosely as slot opening gaps become wider over time. This invention also solves the issue of loose connections found in older electrical outlets by providing more consistent electrical contact engagements throughout the product life.

### Description of Related Art

There are existing electrical outlets that rotate the entire outlet receptacle in X, Y, or Z-axis for various reasons such as providing more room for bulky chargers, locking features for safety and individual switching functions, however none have the unique capability of engaging and disengaging an electrical plug with electrical contacts using the feature of presented invention with the goal of providing an easy unplugging mechanism for the electrical plug.

### BRIEF SUMMARY

The presented invention has been accomplished to provide an electrical outlet assembly that solves the aforementioned problems, comprising: a rotatable receptacle with slots that allow insertion of an electrical plug that has a built-in loop spring and contact walls for pressing onto prongs of the plug, a housing assembly (base housing and top housing) with rim structures providing a circular rail for the receptacle to mate and rotate on, and contact supports in the housing assembly for installation of electrical contacts.

The outlet assembly is configured such that by rotating the receptacle with the electrical plug inserted, the prongs on the plug are shifted between electrically disconnected while mechanically disengaged position and electrically connected while mechanically engaged position. When the prongs are connected and engaged, the contact walls in the receptacle and contact supports in the base housing compress on the prongs and contacts in a sandwiched manner by the force provided by a spring and latch mechanism.

### BRIEF DESCRIPTION OF DRAWINGS

In order for the invention to be more fully understood brief descriptions are given with reference to the accompanying drawings in which:

FIG. 1 is an exploded view of the electrical outlet assembly.

FIG. 2 is a perspective view of the base housing with electrical contacts installed.

FIG. 3 is a perspective view of the electrical outlet assembly and an electrical plug.

FIG. 4 is a top view of the electrical outlet assembly with receptacle in disconnected position.

FIG. 5 is a top view of the electrical outlet assembly with receptacle in connected position.

FIG. 6 is a perspective view of the base housing showing internal features.

FIG. 7 is a perspective view of the receptacle showing the top surface and loop spring.

FIG. 8 is a perspective view of the receptacle showing internal features.

FIG. 9 is a perspective view of the top housing showing top surface.

FIG. 10 is a perspective view of the top housing showing internal features.

FIG. 11 is a perspective view of the electrical contacts with wires installed.

FIG. 12 is a perspective view of the base housing, receptacle, and plug in disconnected position.

FIG. 13 is a perspective view of the base housing, receptacle, and plug in connected position.

FIG. 14 is a perspective view of the base housing and plug without showing the receptacle in disconnected position.

FIG. 15 is a perspective view of the base housing and plug without showing the receptacle in connected position.

FIG. 16 is a cross-sectional view of the base housing, receptacle and plug in disconnected position.

FIG. 17 is a cross-sectional view of the base housing, receptacle and plug in connected position.

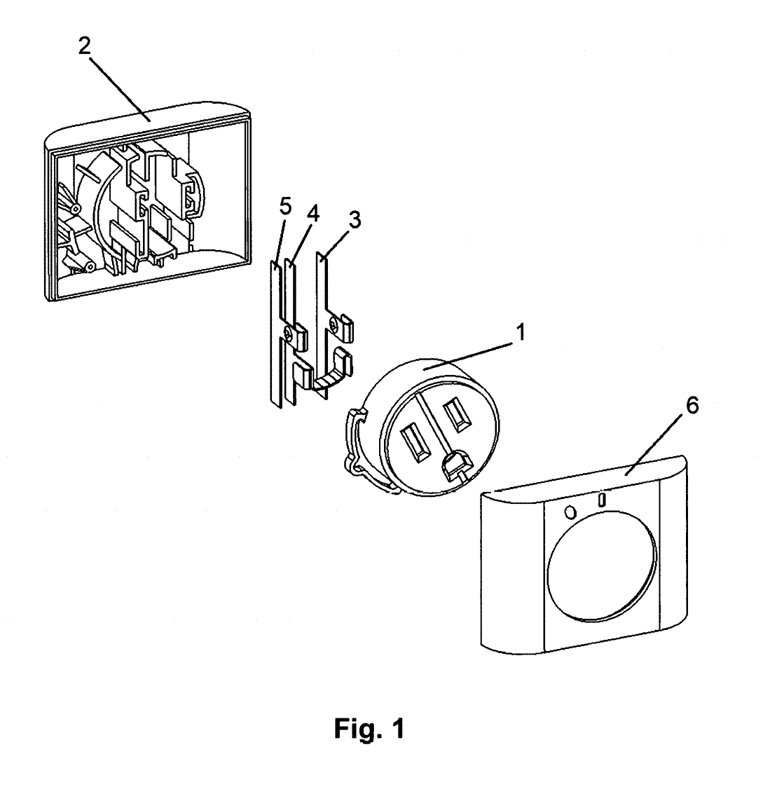

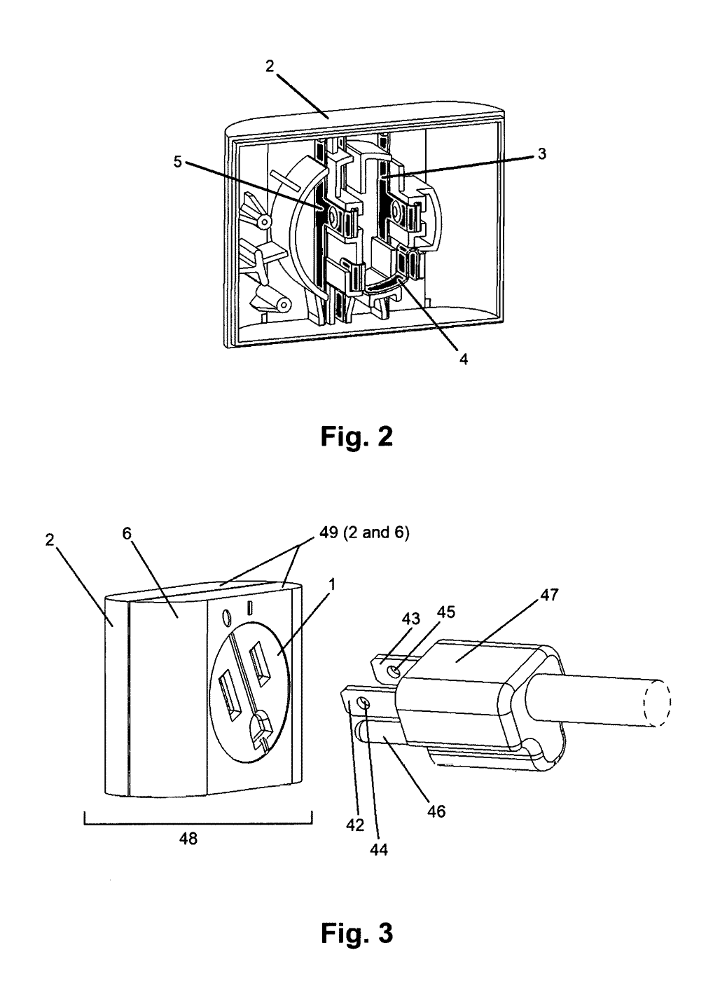

LIST OF REFERENCE NUMERALS:

```
  (1) Receptacle
  (2) Base Housing
  (3) Electrical Contact - Hot
  (4) Electrical Contact - Ground
  (5) Electrical Contact - Neutral
  (6) Top housing
  (7) Wire - Hot
  (8) Wire - Ground
  (9) Wire - Neutral
(10) Contact Support - Hot
(11) Contact Support - Neutral
(12) Contact Support - Ground
(13) Contact Slot - Hot
(14) Contact Slot - Neutral
(15) Contact Slot - Ground
(16) Up-Turn Limiter
(17) Down-Turn Limiter
(18) Spring Tensioner
(19) Separating Wall
(20) Retaining Wall
(21) Mating Rim
(22) Outlet Opening
(23) Outlet Retaining Rim
(24) Disconnected State Indicator
(25) Connected State Indicator
(26) Loop Spring
(27) Spring Bump
(28) Indicator Groove
(29) Receptacle Slot - Neutral
(30) Receptacle Slot - Hot
(31) Receptacle Slot - Ground
(32) Mating Step - Top
(33) Mating Step - Bottom
(34) Contact Wall - Neutral
(35) Contact Wall - Hot
(36) Insert Tab - Neutral
(37) Insert Tab - Hot
(38) Insert Tab - Ground
(39) Support Tab - Ground
(40) Bump - Neutral
(41) Bump - Hot
(42) Prong - Neutral
(43) Prong - Hot
(44) Prong Hole - Neutral
(45) Prong Hole - Hot
(46) Ground Pin
(47) Electrical Plug
(48) Electrical Outlet Assembly
(49) Housing Assembly
```

### DETAILED DESCRIPTION

The invention was developed to address the issues of traditional electrical outlets being difficult to unplug an electrical plug from—especially power strips that are relocatable and not mounted to walls or floors. A traditional outlet has fixed structures around electrical contact slots so that prongs of the electrical plug inserted are held in position by the frictional force maintained based on tightness of the slots. This frictional force must be overcome by a user when pulling the plug away from the electrical outlet often with difficulty with both hands.

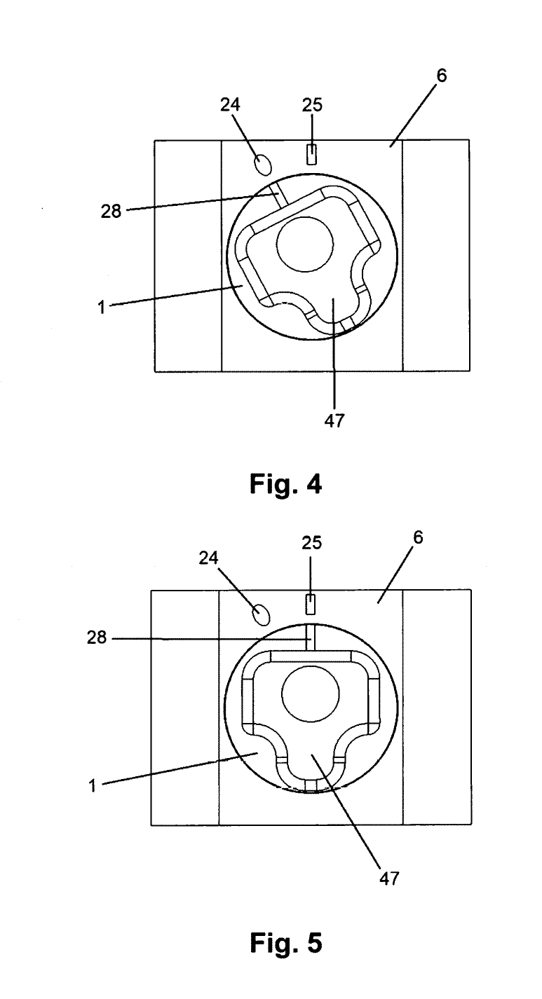

The main aspect and advantage of the presented invention is provided by the easy unplugging mechanism that greatly facilitates the unplugging experience of an electrical plug 47 from an outlet receptacle 1 that can be rotated to two different angle positions; roughly to the 10 o'clock angle position where disconnected state indicator 24 is displayed as symbol “0” and to the 12 o'clock angle position where connected state indicator 25 is displayed as symbol “I” on the outer surface of top housing 6 along outlet opening 22 as shown in FIGS. 4, 5, and 9.

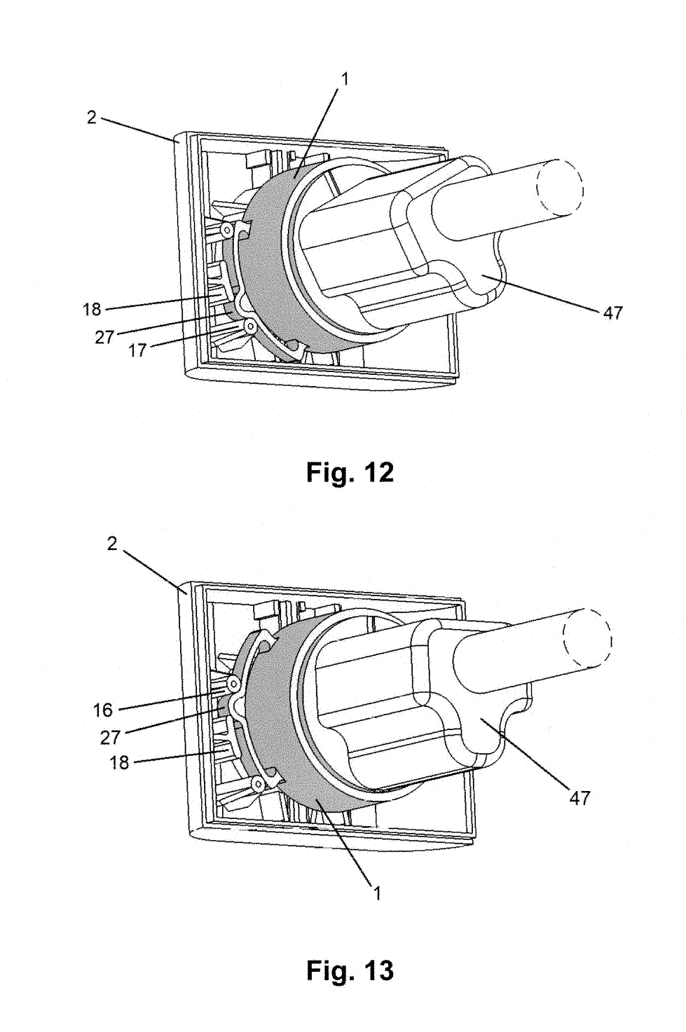

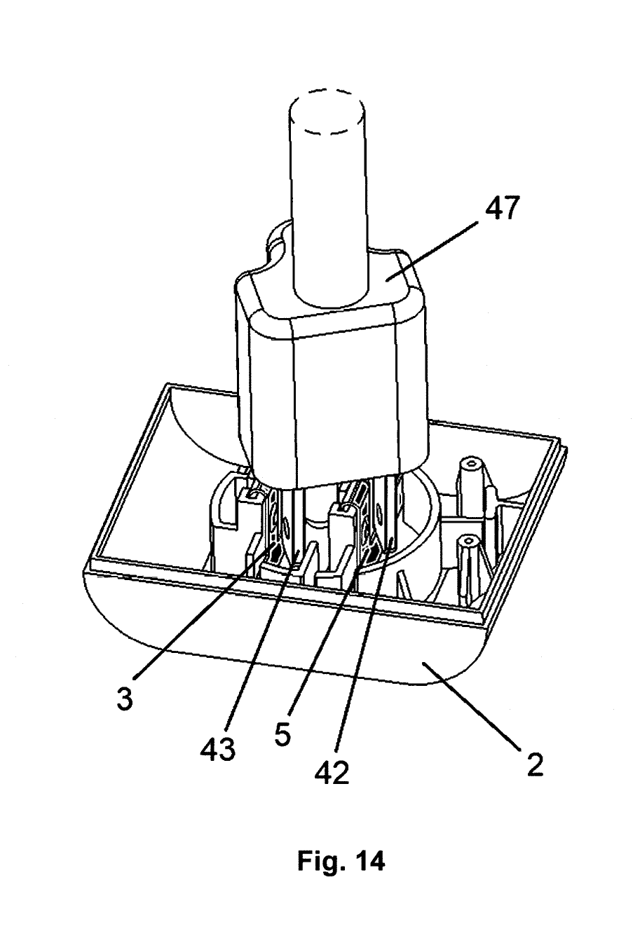

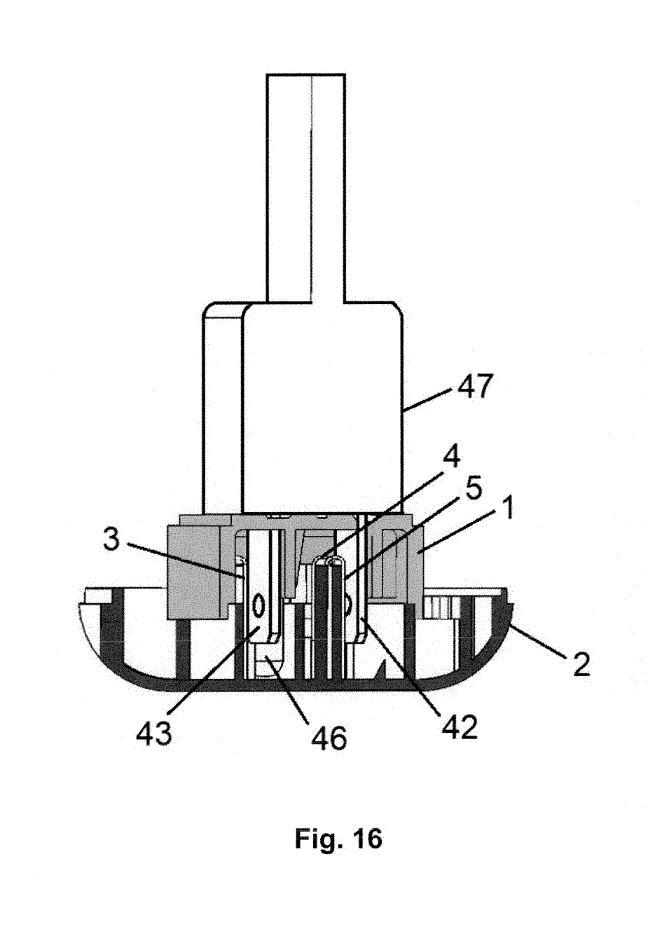

Electrical outlet assembly 48 and electrical plug 47 are mechanically disengaged; i.e. the plug 47 does not experience frictional force on prongs 42, 43 and electrically disconnected as shown in FIGS. 4, 12, 14 and 16 when the plug 47 is rotated in counterclockwise direction until indicator groove 28 is aligned with the disconnected state indicator 24. Upon disengagement, there is little to no frictional force between the prongs 42, 43 of the plug 47 and electrical contacts 3, 5 installed on base housing 2's contact supports—hot and neutral 10, 11 hence allowing the plug 47 to be lifted away easily from the receptacle 1 with little to no interfering force. Down-turn limiter 17 keeps the receptacle 1 from rotating further in counterclockwise direction beyond the angle indicated by the disconnected state indicator 24.

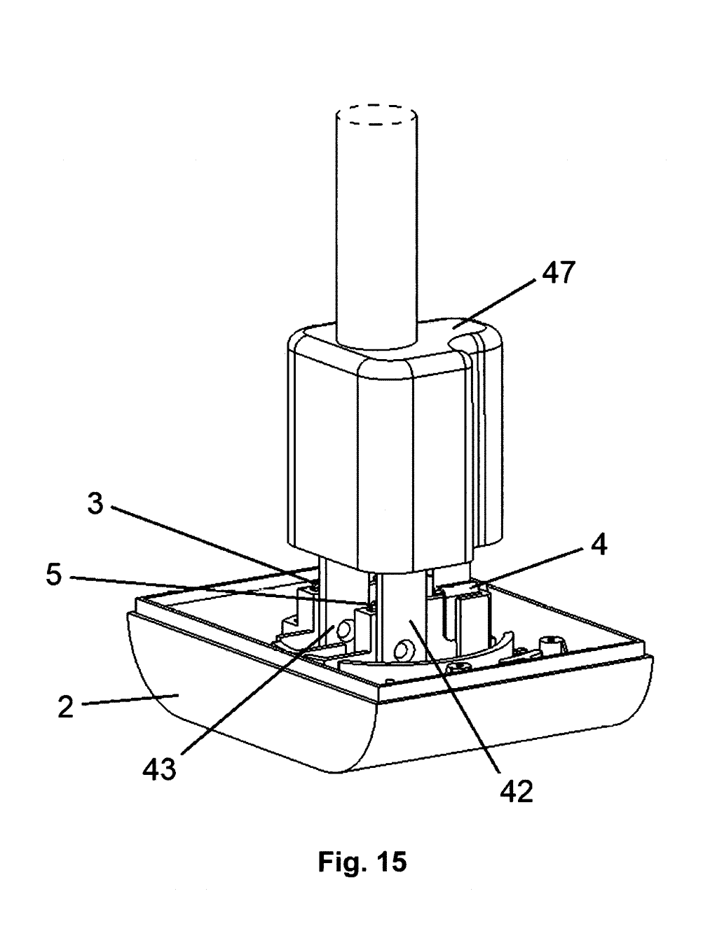

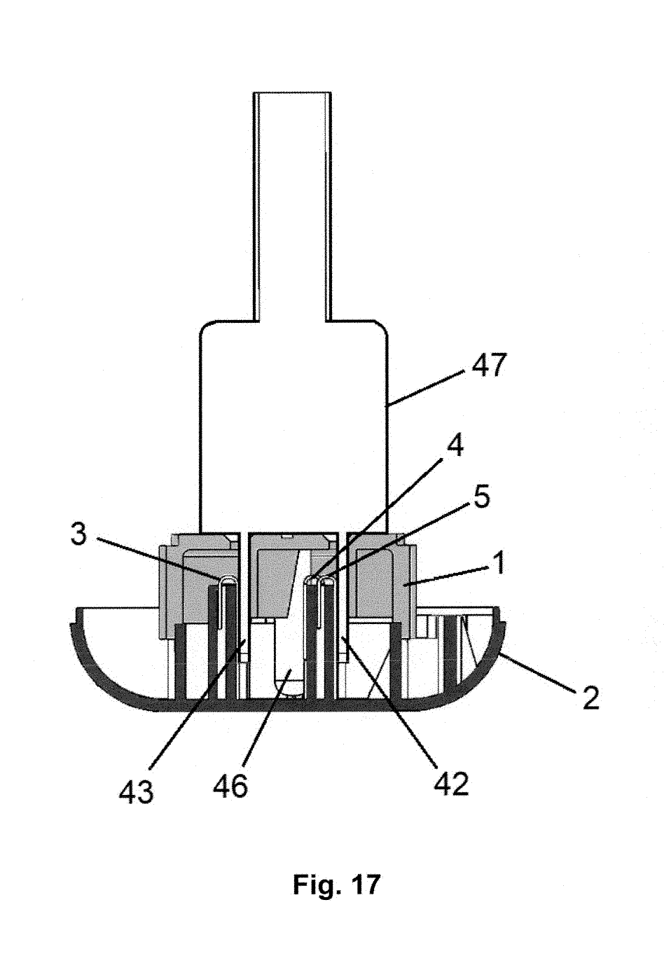

The outlet assembly 48 and the plug 47 are mechanically engaged; i.e. resist from being pulled away from the receptacle 1 and electrically connected as shown in FIGS. 5, 13, 15 and 17 when the plug 47 is inserted into the receptacle 1 and rotated in clockwise direction until the indicator groove 28 is aligned with the connected state indicator 25. Due to dimensional tolerances in prongs 42, 43, the indicator groove 28 may not align perfectly with the connected state indicator 25. The force required to keep the prongs 42, 43 pressed against the electrical contacts 3, 5 is generated by the collision between a loop spring 26 and spring tensioner 18. FIG. 13 shows one design example of the loop spring 26 and spring tensioner 18 with a mechanism that can provide the force needed to prevent the receptacle 1 from rotating in counterclockwise direction. When spring bump 27 of the loop spring 26 sits between the spring tensioner 18 and up-turn limiter 16, there is clockwise tangential force exerted onto the spring bump 27 by the spring tensioner 18 which holds the receptacle 1 in place. Bumps—neutral and hot 40, 41 on the electrical contacts—neutral and hot 5, 3, being slipped into prong holes 44, 45 further assist in retaining the electrical plug 47 plugged in the receptacle 1 by resisting perpendicular pulling force. The up-turn limiter 16 prevents the receptacle 1 from rotating further in clockwise direction beyond the angle indicated by the connected state indicator 25.

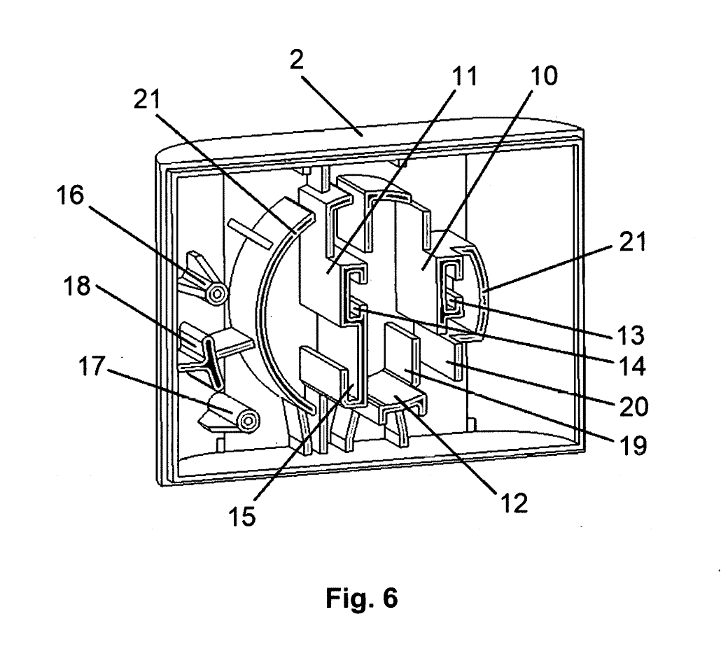

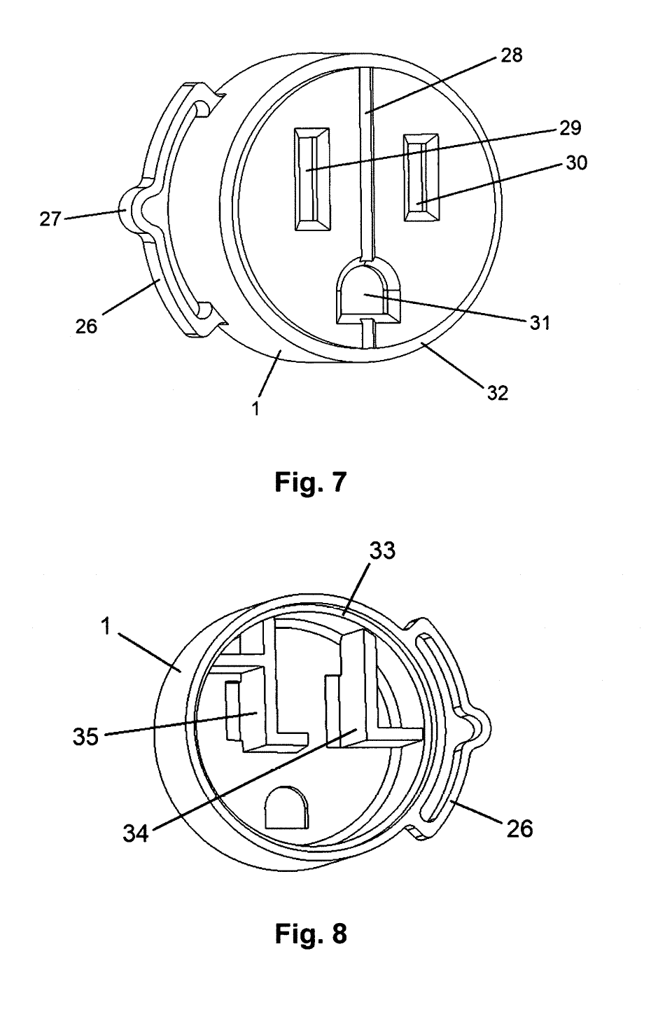

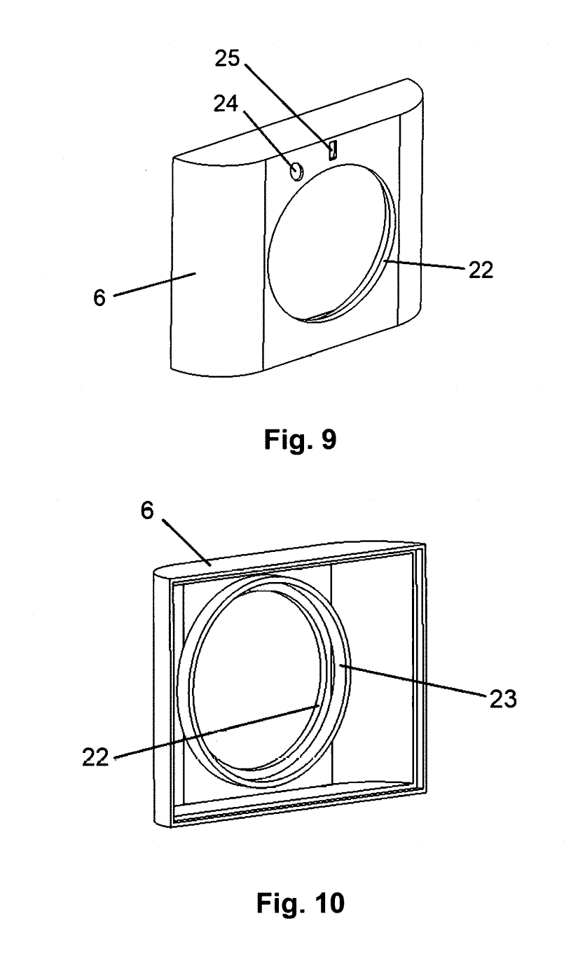

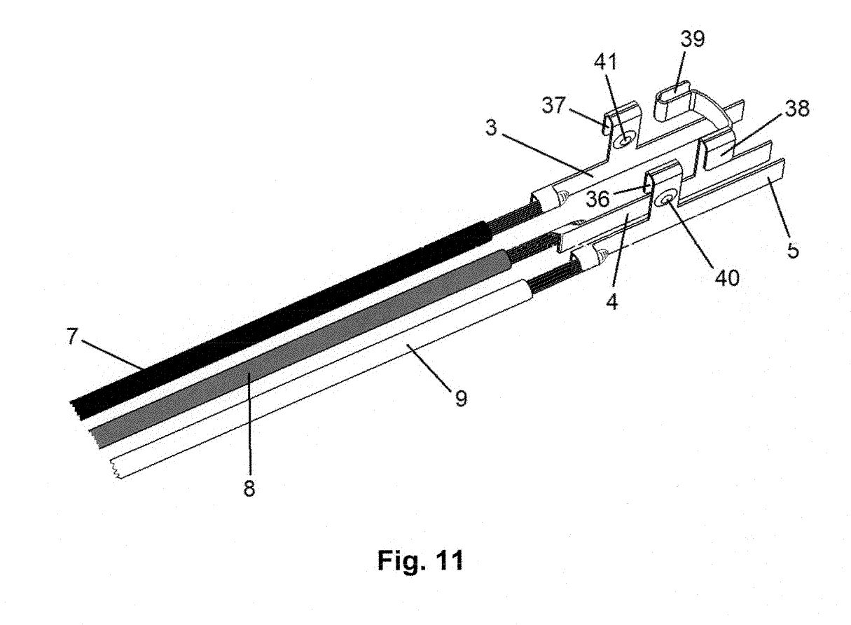

FIG. 6 shows details on the base housing 2 with mating rim 21 providing a circular rail structure for the receptacle 1 to rotate on. The mating rim 21 is partially cut to make paths for the electrical contacts 3, 4, 5 to run through. There are contact supports 10, 11, 12 that facilitate mounting of the electrical contacts 3, 4, 5 where insert tabs 36, 37, 38 from the electrical contacts 3, 4, 5 are bent and folded over to be held in place by flange on flanking side(s) that create contact slots 13, 14, 15. Housing assembly 49 comprising, top housing 6 and base housing 2 are assembled together to concentrically align and enclose the receptacle 1 along the axis of rotation shared by mating steps 32, 33 of the receptacle 1, outlet retaining rim 23 and mating rim 21 of the base housing 2.

Contact walls 34, 35 of the receptacle 1 can be urged to compress onto the prongs 42, 43 by mechanisms designed in various forms with either integrated or separate components. A built-in loop spring 26 on the receptacle 1 and the up/down-turn limiters 16, 17 on the base housing 2 are shown herein as an example for better understanding of the described mechanism.

Application—power tap or power strip can take advantage of this invention by using multiple outlet assemblies in tandem or parallel configurations. The easy to unplug mechanism provided by this invention makes unplugging electrical plugs from power strips placed far behind or under furniture much easier and quicker without struggling in awkward positions.

1- An electrical outlet assembly comprising:
a housing assembly that consists of a top housing and a base housing,
a rotatable receptacle within said housing assembly adapted to axially receive contact prongs of an electrical plug,
a pair of walls raised perpendicularly from flat inner round surface of said receptacle,
three walls with flanking flanges in said base housing raised perpendicularly from flat inner floor surface of said base housing,
three electrical contact elements fixed to said three walls of said base housing,
rotation means in said housing assembly operatively rotatable relative to said receptacle in response to the axial insertion of said prongs of said electrical plug into said receptacle and a rotation on a circular rim,
in the clockwise direction that moves said prongs closer towards said electrical contact elements to the coinciding angular position where said prongs press onto and electrically connect to said electrical contact elements, and
in the counterclockwise direction that moves said prongs away from said electrical contact elements to an offset angular position where said prongs are not pressed onto said electrical contact elements.

2- An electrical outlet assembly in accordance with claim 1 wherein said rotation means includes,
engagement means on said housing assembly and said receptacle, and
spring means between said base housing and said receptacle that normally resists said receptacle from rotating.

3- An electrical outlet assembly in accordance with claim 2 includes an integrated and partially spanning loop spring with a bump on said receptacle's outer cylindrical surface adapted to resist rotation of said receptacle when said bump is subjected to frictional force while rotating on said circular rim of said base housing.

4- An electrical outlet assembly in accordance with claim 2 includes a spring tensioner that generates frictional force upon said spring tensioner coming in collision with said bump on said loop spring of said receptacle while said receptacle is rotating on said circular rim of said base housing.

5- An electrical outlet assembly in accordance with claim 1 wherein said means for rotating said receptacle is rotatable to and from said coinciding angular position and said offset angular position while mated to said circular rim and enclosed in said housing assembly.

6- An electrical outlet connection comprising:
an electrical outlet assembly including,
a housing assembly that consists of a top housing and a base housing,
a rotatable receptacle within said housing assembly having receptacle slots for receiving the prongs of said electrical plug,
a pair of walls raised perpendicularly from flat inner round surface of said receptacle adapted to press onto said contact prongs of said electrical plug when inserted and rotated in the clockwise direction,
three walls with flanking flanges in said housing raised perpendicularly from flat inner floor surface of said housing,
three electrical contact elements fixed to said three walls in said housing adapted to be connected to a source of electrical power,
means for rotating said receptacle to an angular position where said prongs of said electrical plug and said electrical contact elements are electrically connected,
said rotation means including,
an integrated and partially spanning loop spring with a bump on said receptacle's outer cylindrical surface adapted to resist rotation when said bump is subjected to frictional force,
a spring tensioner that generates frictional force upon said spring tensioner coming in collision with said bump on said loop spring in said receptacle that results in flexing said spring's shape closer towards said receptacle's outer cylindrical surface in response to said receptacle rotating to and from said coinciding and offset angular positions,
spring means between said housing and said receptacle with said electrical plug inserted that normally resists said receptacle from rotating,
in the counterclockwise direction that keeps said contact prongs of said electrical plug pressed onto said electrical contact elements at said coinciding angular position where said prongs are electrically connected to said electrical contact elements in said housing, and
in the clockwise direction that keeps said prongs of said electrical plug at said offset angular position where said prongs are not pressed onto said electrical contact elements and can be pulled away from said receptacle easily,
as a result of said frictional force generated between said spring tensioner of said housing and said bump of said loop spring of said receptacle.
